(19) United States
(12) Patent Application Publication
(10) Pub. No.: US 2012/0254034 A1
(43) Pub. Date: Oct. 4, 2012

(54) METHOD FOR PERFORMING ACQUIRER ROUTING AND PRIORITY ROUTING OF TRANSACTIONS

(75) Inventors: Scott R. STATLAND, Lake Saint Louis, MO (US); Kevin P. Carroll, Brookfield, CT (US); Michael R. Adamski, Defiance, MO (US); Alex I. Inovenkov, O'Fallon, MO (US)

(73) Assignee: MasterCard International Incorporated, Purchase, NY (US)

(21) Appl. No.: 13/078,374

(22) Filed: Apr. 1, 2011

(51) Int. Cl. G06Q 40/00

(52) U.S. Cl. 705/44; 705/39

(57) ABSTRACT

A financial processing system for determining a financial network for routing an electronic transaction includes a network BIN database including a plurality of terminal routing profiles. Each routing profile includes at least a corresponding bank identification number (BIN) and a prioritized list of preferred financial networks of an associated terminal created by a transaction acquirer. The financial processing system provides a BIN file including a plurality of BINs and indicating financial networks having claimed priority over any of said BINS from the plurality. From the routing profile of a terminal, the financial processing system determines a financial network preferred by the transaction acquirer for routing said electronic transaction, and from the BIN file, determines if at least one network flag is marked indicating a network's claim of priority over the BIN. The financial processing system then selects a financial network for routing the electronic transaction based on at least one of the BIN file information and the routing profile.

### FIELD OF THE INVENTION

The present invention relates to systems and methods for routing electronic transactions through financial (e.g., debit/credit networks). In particular, the present invention relates to the determination of a proper and/or desired financial network for routing electronic transactions for processing.

### BACKGROUND OF THE INVENTION

In recent years, the increase of electronic transactions in the marketplace has resulted in an increase in cost and volume of such electronic transactions, thereby causing concern for transaction acquirers (e.g., merchants, automated teller machine (ATM) networks, etc.) and debit/credit processors. Currently, many financial processing networks exist, from which debit/credit processors can select for routing electronic transactions. In fact, most processors have set preferred default networks or have a prioritized list of preferred default networks for automatically routing electronic transactions for processing/authorization. In most cases, an electronic transaction routed via a default network set by the credit/debit processor will result in a financial benefit for the credit/debit processor.

While credit/debit processors of known financial systems can determine preferred/default networks to which electronic transactions are to be routed, the transaction acquirer of the same known systems have been bound to the routing decisions made by the debit/credit processors. Current systems do not allow for routing selections to be made by transaction acquirers. Thus, financial benefits are not necessarily seen by the transaction acquirers nor can they maximize their income by selecting financial networks with optional interchange fees.

Thus, the current inventors perceive a need exists for improved systems and methods for not only permitting credit/debit processing companies to select financial routing networks for electronic transaction authorization but also for permitting transaction acquirers to select and/or prioritize financial routing networks.

### SUMMARY OF THE INVENTION

Systems and methods for determining a financial network for routing electronic transactions are disclosed herein.

At the onset, it is noted that as used herein, the term “cardholder,” “card user,” and “card recipient” can be used interchangeably and can include any user making purchases of goods and/or services. Further, as used herein in, the term “issuer” or can include, for example, a financial institution (i.e., bank) issuing a card, a merchant issuing a merchant specific card, a stand-in processor configured to act on-behalf of the card-issuer, or any other suitable institution configured to issue a financial card. Finally, as used herein, the term “transaction acquirer” can include, for example, a merchant, a merchant terminal, an automated teller machine (ATM), or any other suitable institution or device configured to initiate a financial transaction per the request of a cardholder.

One aspect of exemplary embodiments of the disclosed financial routing system involves a method for determining a financial network for routing an electronic transaction. The system provides a network bank identification number (BIN) database including a plurality of routing profiles of a transaction acquirer, wherein each terminal routing profile includes at least a corresponding BIN and a prioritized list of preferred financial networks of an transaction acquirer. The system also provides a BIN file including a plurality of BINs and indicating financial networks having claimed priority over any of the BINs from the plurality of BINs. From the routing profile of the transaction acquirer, a preferred financial network is determined for routing the electronic transaction, and, from the BIN file, a determination is made as to whether or not at least one network is indicated as having a claim of priority over the BIN. The financial routing system then selects a financial network based on at least one of the BIN file information and the routing profile of the transaction acquirer.

Another aspect of exemplary embodiments of the disclosed financial routing system involves a method for determining a financial network and routing an electronic transaction to the financial network for processing at an issuer. The system receives transaction information, including a bank identification number (BIN), from a transaction acquirer and determines, from a routing profile of the transaction acquirer, a preferred financial network for routing the electronic transaction. The received routing profile includes at least the BIN and a prioritized list of financial networks created by the transaction acquirer. The routing system then determines, from a BIN file, if at least one network is indicated as having a claim of priority over the BIN, and selects a financial network based on at least one of the BIN file information and the routing profile. The system then routes the electronic transaction to the selected financial network for authorization and/or processing.

One aspect of exemplary embodiments of the disclosed financial routing system for determining a financial network for routing an electronic transaction includes a communication interface device configured to communicate with a communications network, a memory device, and a computer processing device. The memory device includes a network bank identification number (BIN) database and a BIN file. The BIN database includes a plurality of routing profiles, each routing profile including at least a corresponding BIN and a prioritized list of preferred financial networks of an associated transaction acquirer. The BIN file includes a plurality of BINs and indicates if any networks have claimed priority over any one of the BINs from the plurality of BINs. The computer processing device is configured to receive transaction information including a BIN from a transaction acquirer, to search the network BIN database for the routing profile of the transaction acquirer transmitting the transaction information, and to search the BIN file for network claims of priority. The computer processing device is further configured to select a financial network for routing the electronic transaction based on at least one of the routing profile and the network priority claims in the BIN file.

### BRIEF DESCRIPTION OF THE DRAWINGS

The exemplary embodiments of the disclosed systems and methods can be better understood with reference to the following drawings and description. The components in the figures are not necessarily to scale, emphasis instead being placed upon illustrating the principles of exemplary embodiments of the disclosed system. Moreover, in the figures, like reference numerals designate corresponding parts through the different views.

FIG. 1 illustrates a block diagram of a financial routing system according to an embodiment of the disclosed system.

FIGS. 2 and 3 are block diagrams illustrating bi-directional communication between the financial routing system of FIG. 1 and parties external to the system.

FIGS. 4A-4B illustrate examples of routing profiles of transaction acquirers according to embodiments of the disclosed financial routing system.

FIG. 5 is a flow chart illustrating a method of selecting a financial network via the financial routing system of FIG. 1.

FIG. 6 is a flow chart illustrating a method of selecting a financial network and routing an electronic transaction via the financial routing system of FIG. 1.

FIG. 7 illustrates a workflow diagram illustrating communication between individual parties of the financial system of FIGS. 2 and 3 for determining a network for routing an electronic financial transaction.

Further areas of applicability of the present disclosure will become apparent from the detailed description provided hereinafter. It should be understood that the detailed description and exemplary embodiments are intended for purposes of illustration only. Thus, the detailed description and exemplary embodiments are not intended to necessarily limit the scope of the disclosure.

### DETAILED DESCRIPTION OF THE DRAWINGS

The disclosed embodiments include a financial routing system and a method for routing electronic transactions. The disclosed system and method provide routing of electronic transactions using routing profiles provided by transaction acquirers. The systems and methods disclosed herein generally comprise selecting a financial network for routing the electronic transaction based on the transaction acquirer's routing profile and settings in the bank identification number (BIN) file.

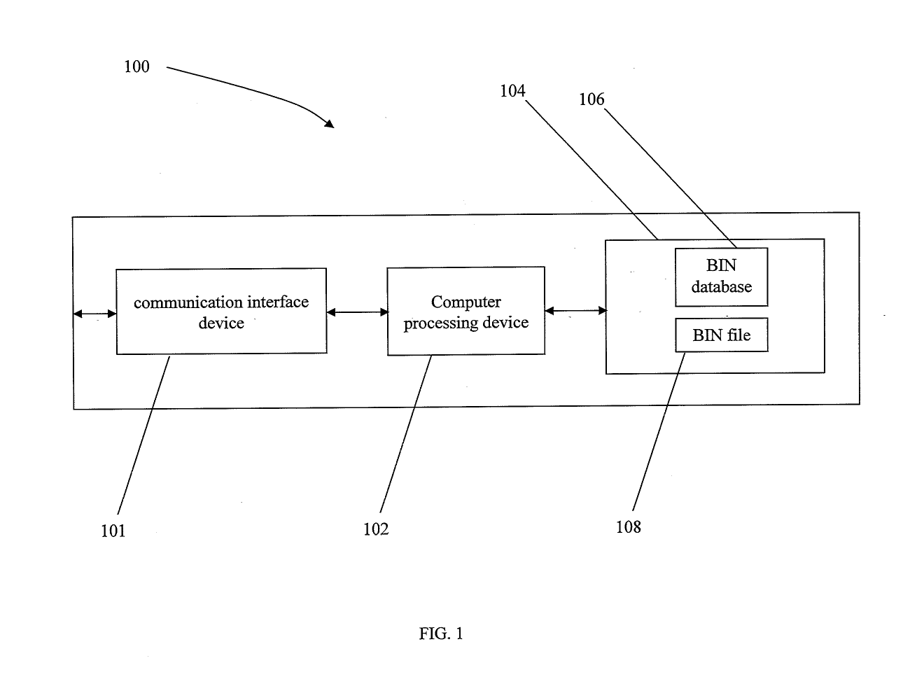

FIG. 1 illustrates a block diagram of a financial routing system 100 for routing financial transactions according to an embodiment of a disclosed system. The financial routing system 100 includes a communication interface device 101, a computer processing device 102 and a memory device 104.

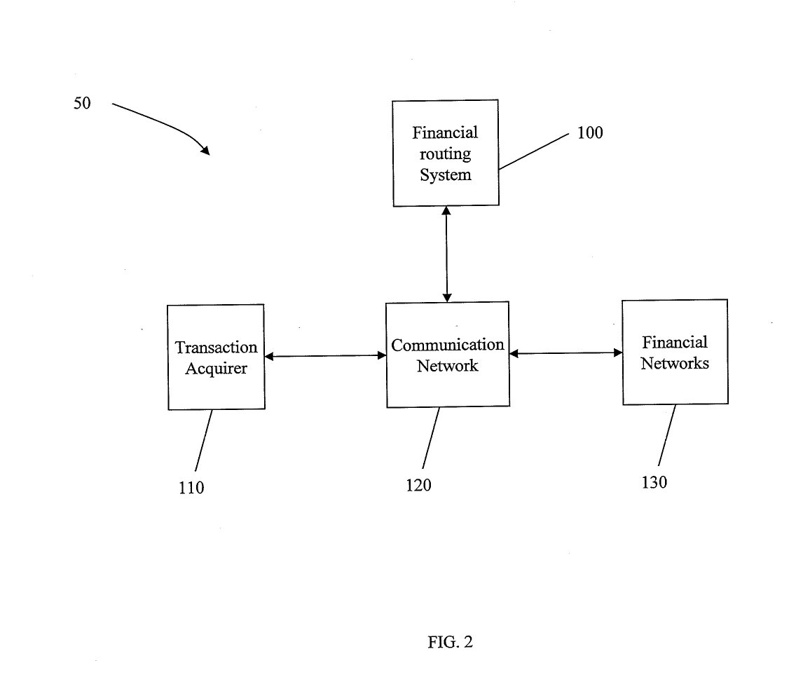

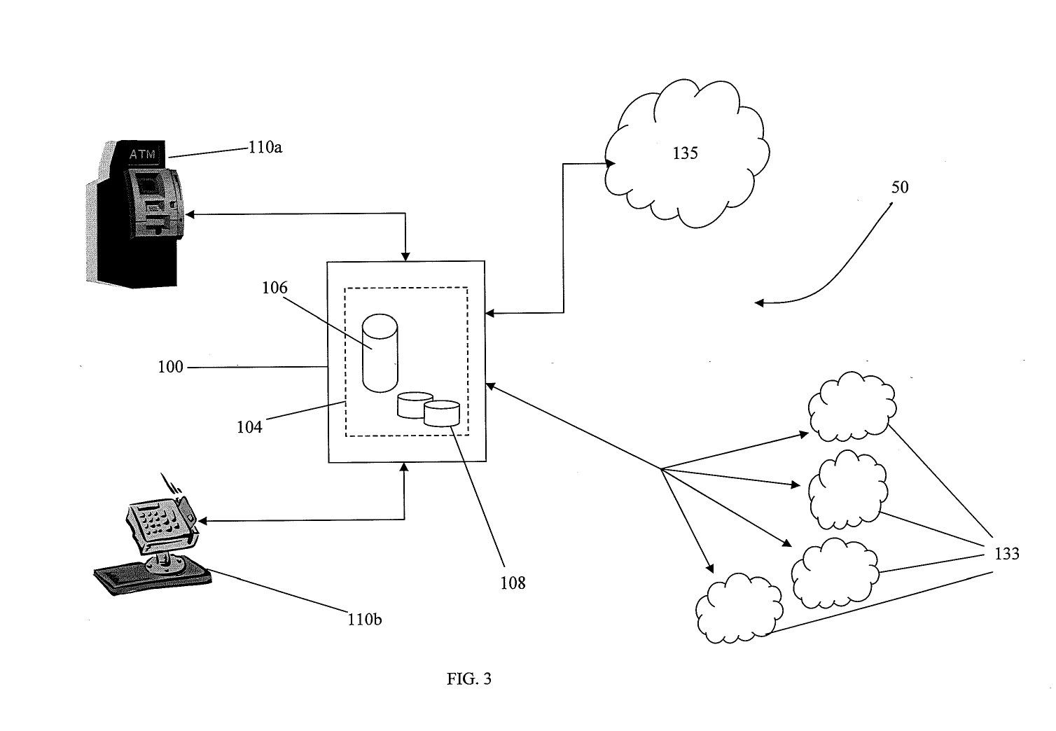

The financial routing system 100 is implemented in a financial system 50 (illustrated in FIGS. 2 and 3) including, in addition to the financial routing system 100, at least a plurality of transaction acquirers 110 and a plurality of financial networks 130. The financial system 50 can be implemented in a communications network environment 120. Specifically, in the financial system 50, the processing system 100, transaction acquirers 110, and financial networks 130 are in communication via the communication network 120. The communication network 120 can be any suitable communications network configured to support electronic financial transactions (e.g., debit, credit, automated teller machine (ATM) transactions, etc.). Suitable communication networks include, but are not limited to, a wide area network (WAN), a local area network (LAN), the Internet, etc.

The communication interface device 101 of the financial routing system 100 (shown in FIG. 1) provides one or more communications paths from the financial routing system 100 to and from other electronic devices and/or computer systems. Such communication paths can include, for example, one or more communication networks 120 (discussed above and shown in FIG. 2) or can include remote device communication lines, wireless connections, etc. The communication interface device 101 is configured to receive, from a transaction acquirer 110 (shown in FIG. 2), information pertaining to an electronic financial transaction and to communicates the transaction information to other devices/modules of the financial system 50. A transaction acquirer can be, for example, an ATM 110 (shown, e.g., in FIG. 3) a merchant terminal 110b (point-of-sale (POS) terminal) (shown, e.g., in FIG. 3), etc.

The computer processing device 102 of the financial routing system 100 is configured to receive the financial transaction information from the transaction acquirer 110 via the communication interface 101 and to communicate with the memory device 104. The processing device 102 is configured to select a financial network from a plurality of financial networks 130 for routing the financial transaction based on information stored in the memory device 104. The plurality of financial networks can include default financial networks 135 (shown, for example, in FIG. 3) set by the computer processing device 102 of the financial routing system 100 to which the system 100 directly links. The financial networks also include networks 133 to which the system 100 does not directly link, which have been selected by a transaction acquirer 110 (e.g., ATM 110a or merchant terminal 110b) (discussed in more detail herein). The financial networks discussed above, can be any known debit or credit network, including, for example, STAR, PULSE, INTERLINK, MAESTRO, CU24, AFFN, ACCEL, EXCHANGE, NETS, SHAZAM, ATH, ALASKA OPTION, JEANIE, TEMPO PAYMENTS, CIRRUS, FASTBANK, INSTANT CASH, MINIBANK, MONEY NETWORK, PEAK, PLUS, NYCE, ALERT, VISA, MasterCard, etc. However, any suitable debit and/or credit network available in the geographic location of interest can be used.

The memory device 104 of the financial routing system 100 is configured to store a variety of information pertaining to the financial routing system 100 and parties external to the financial routing system (e.g., transaction acquirers 110, card issuer, etc.). The memory device 104, while illustrated in FIG. 1 as being external to the computer processing device 102, can, in alternative embodiments, be implemented within the computer processing device 102. Moreover, the memory device can include any type of short term, long term, volatile, nonvolatile, or any other suitable computer-readable storage medium. Moreover, while the memory device 104 is illustrated in FIGS. 1 and 3 as being a single device, in alternative embodiments, the financial routing system 100 can include a plurality of memory devices.

The memory device 104 comprises a network bank identification number (BIN) database 106, a BIN file 108, instructions to receive electronic financial transaction information from a transaction acquirer 110 via the communication interface 101, instructions to locate the BIN associated with the received financial transaction information, instructions to select an appropriate financial network for routing the financial transaction (disclosed in more detail herein), and instructions to route the financial transaction to the selected financial network (disclosed in more detail herein).

The network BIN database 106 stored within memory device 104 includes a plurality of network routing profiles for transaction acquirers 110 associated with the financial routing system 100 and includes a BIN file 108. Specifically, the network BIN database 106 is configured to define and document the transaction acquirers' routing profiles such that the financial routing system 100 can implement/set a transaction acquirer's profile and use the profile in conjunction with a stored BIN record when determining/selecting a financial network to which a transaction will be routed for authorization/processing. Each routing profile is created and defined according to each corresponding transaction acquirers' input, and includes information such as desired/preferred financial networks for routing transactions, a prioritized list of such desired networks, and an addition of a flag indicating a preferred routing method, i.e., acquirer routing method or priority routing method (discussed in more detail herein). In other words, a transaction acquirer can provide a list of preferred networks and to select one of two different routing methods, which is entirely at the transaction acquirer's discretion, for routing transactions for processing. In some embodiments, the routing profiles can also include information pertaining to the different types of transactions that an acquirer chooses to be included in or excluded from various preferred networks (include/exclude indicator), the BIN, the BIN check length, and the six character processing code (i.e., transaction type). Thus, the setting and storing of a routing profile in the network BIN database 106 allows a transaction acquirer to determine which networks to route transactions to for authorization.

The BIN file 108 of the financial routing system 100 is an accumulation of BIN records received from corresponding card issuers (e.g., banks). Thus, each BIN record stored in the BIN file 108 corresponds to a particular card issuer and includes preferences set by the corresponding card issuer. Each BIN record in the BIN file 108 includes a plurality of flags containing information that can be taken into account when determining the financial network to route the transaction to (depending on the preferred routing method). For example, settings in a given BIN record can include at least one network selected by the card issuer that claims priority over a particular BIN.

Specifically, the each BIN record includes (1) a file header record, (2) a batch header record, (3) a detail record, (4) a batch trailer record, and (5) a file trailer record. The BIN file 108 is configured to include multiple batches. For example, a particular BIN record can include BINs for only one network and, thus, would contain (1) a file header, (2) a batch header for the one network, (3) a detail record for the BIN associated with the one network, (4) a batch trailer for the one network, and (5) a file trailer record. In yet another example, the BIN file 108 can include two different networks and, thus, would contain (1) a file header (only one), (2a) a batch header for network 1, (3a) a detail record for each BIN associated with network 1, (4a) a batch trailer for network 1, (2b) a batch header for network 2, (3b) a detail record for each BIN associated with network 2, (4b) a batch trailer for network 2, and (5) a file trailer (only 1). Each record noted above is 120 characters in length and includes a plurality of flags containing information for network determination.

A batch header record of each BIN record includes information such as file record type, a creation date (i.e., date the file was created), a recipient identifier (i.e., whom the record was assigned by), a network identifier, which identifies the network associated with the BINs found in the batch, and a network description, which provides a description of the network associated with the group of BINs found in the batch.

A BIN file detail record of the BIN record includes information such as the BIN (i.e., the BIN that is enrolled in the network associated with the network identifier identified in the batch header), a BIN length, a PAN (personal account number) length (i.e., length of the card numbers that are associated with the BIN), an issuer country code (i.e., the three-digit country code of the issuer BIN), an ATM indicator, which indicates if the BIN is eligible for ATM transactions for the network associated with the batch (“Y”—BIN is ATM eligible; “N”—BIN is not ATM eligible), a POS (point-of-sale) indicator, which indicates if the BIN is eligible for POS transactions for the network associated with the batch (“Y”—BIN is POS eligible; “N”—BIN is not POS eligible), a network ATM priority routing indicator, which indicates if the BIN has elected to have the network associated with the batch identified as an ATM priority routed network (“Y”—network is an ATM priority routing network for the BIN; “N”—network is not an ATM priority routing network for the BIN), and a network POS priority routing indicator, which indicates if the BIN has elected to have the network associated with the batch identifies as a POS priority routed network (“Y”—network is a POS priority routing network for the BIN; “N”—network is not a POS priority routing network for the BIN).

The BIN file detail record also includes a PINIess debit indicator, which indicates if the BIN is capable of processing a PINIess debit transaction for the network associated with the batch (“Y”—BIN is a PINIess debit BIN; “N”—BIN is not a PINIess debit BIN), a deposit sharing indicator, which indicates if the BIN participates in a deposit sharing program for the network associated with the batch (“Y”—BIN is a participant; “N”—BIN is not a participant), an ATM surcharge free indicator (“Y” or “N”), a POS surcharge free indicator (“Y” or “N”), stored value indicator (“Y” or “N”), a platform indicator (“Y” or “N”), and a state code that identifies the state associated with the BIN for the network associated with the batch.

A BIN file batch trailer record of a BIN record includes a record type and a detail record count, which is the number of detail records included in the batch (excluding the batch header and batch trailer records).

A BIN file trailer record of a BIN record includes a record type and a file record count, which is the total number or records contained in the file (including all file header, file trailer, batch header, batch trailer, and detail records).

The information included in a particular portion of the BIN file 108 (e.g., in a given BIN record), discussed above (i.e., file header record, batch header record, detail record, batch trailer record, and file trailer record) can be used in conjunction with the information provided in a transaction acquirer's routing profile stored in the database 103 when determining/selecting a network for routing a financial transaction. Moreover, the financial routing system 100 is configured to receive and store new BIN records for card issuers and can also receive updated BIN records for card issuers to update or overwrite data already stored in memory. The BIN file 108 can be built from new BIN records and/or updated BIN records accordingly to a set schedule. For example, a new and/or updated BIN record can be received and stored on a daily basis, a weekly basis, or a monthly basis. Alternatively, the new and/or updated BIN record can be received sporadically and/or any time decided by the transaction acquirer's processor.

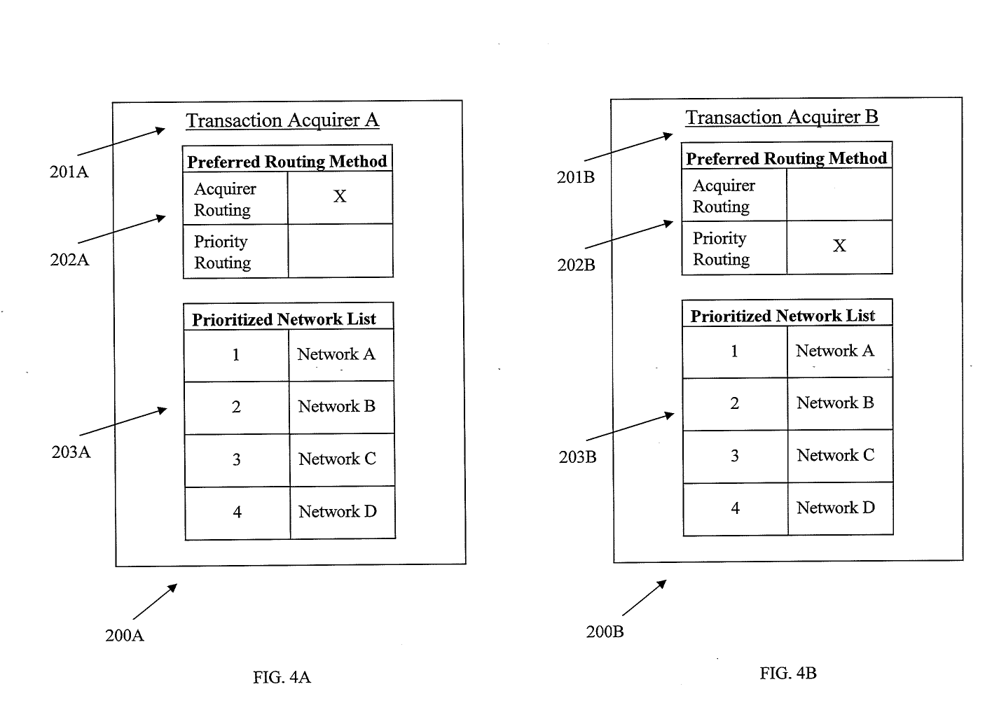

As discussed in detail above, a transaction acquirer's routing profile includes information, for example, preferred financial networks for routing transactions, a prioritized list of such desired networks, and a flag indicating a preferred routing method (i.e., acquirer routing method or priority routing method). Examples of such routing profiles are illustrated in FIGS. 4A and 4B. While FIGS. 4A and 4B only illustrate the name of the transaction acquirer 201A, 201B, the preferred routing method 202A, 202B, and a prioritized list of financial networks 203A, 203B, additional information including the BIN, the BIN check length, and a six character processing code (i.e., transaction type) or portions thereof, for matching purposes may also be included in each routing profile. Further information can be included in each routing profile. For example, in some embodiments, the routing profile can include different types of transactions that an acquirer selects to be included various preferred networks (i.e., include indicator). In other embodiments, the routing profile can include different types of transactions that an acquirer selects to be excluded from various networks (i.e., exclude indicator).

FIGS. 4A and 4B illustrate exemplary embodiments of transaction acquirer profiles stored in the database 106 including a selection of a preferred routing method and a prioritized list of preferred financial networks. The exemplary routing profile for transaction acquirer A (as illustrated in FIG. 4A) includes a preferred routing method 201A that had been selected by transaction acquirer A 201A and includes a prioritized list of preferred networks to route a transaction (e.g., networks A-D in a preferred order of 1-4, respectively). In FIG. 4A, the acquirer routing method has been selected as the preferred routing method, which allows only the routing profile of the transaction acquirer to be used when determining the network for routing a transaction for authorization. In other words, acquirer routing does not utilize some of the information in the BIN file 108 (shown in FIGS. 2 and 3) to assist in network selection. Thus, if acquirer routing method is selected, any network's claim of priority over a particular BIN is ignored. Rather, the determination of a financial network is based on the information (e.g., prioritized list of preferred networks) provided in the routing profile in conjunction with a comparison between indicators provided in the financial transaction request with the flags in the BIN file (discussed in more detail below). As illustrated in the example routing profile of FIG. 4A, the transaction acquirers (e.g., merchant terminal owners, ATM owners, etc.) can maximize their potential income by selecting networks with the highest interchange fees available.

Alternatively, as exemplified in FIG. 4B, a transaction acquirer 201B (transaction acquirer B) has selected the preferred routing method 201B to be the priority routing method. In the priority routing method, both the information in the BIN file 108 (not shown in FIGS. 4A and 4B) and the information provided in the routing profile can be taken into consideration when determining/selecting a financial network for routing the transaction. Specifically, when priority routing is selected as the preferred routing method, the BIN file 108 (not illustrated in FIG. 4B) is referred to in order to determine (1) if the network is an ATM priority routing network for a particular BIN or if the network is a POS priority routing network for the BIN and (2) if and how many networks claim priority over the BIN.

If the BIN file 108 indicates that zero networks claim priority over the BIN, then the transaction acquirer's routing profile is referred to for network selection. Said another way, if none of the BINs are marked in the BIN file as having priority, reference is then made to the prioritized list 203B of preferred networks indicated in the routing profile 200B. If the routing profile does not include a list of preferred networks, then a default network of the financial routing system 100 (illustrated, e.g., in FIG. 1) is selected.

If the BIN file 108 indicates that only one network claims priority over the BIN, the BIN records are then scanned for flags. If flags are found in the BIN records and, if they pass edit checks for the transaction request, the order in the transaction acquirer's routing profile is then ignored, and the transaction proceeds to be routed to the one network indicated in the BIN file.

Finally, if the BIN file 108 indicates that a plurality of networks claiming priority over the BIN, then the routing profile 200B is used in conjunction with the information provided in the BIN file (i.e., priority routing flags, network eligibility, etc.) to determine where the transaction should be routed to. Specifically, the BIN record is scanned for flags. If a flag is found within in the BIN record and the BIN is a match, then the remainder of the records is scanned to determine if any other matches exist (e.g., ATM, POS, etc.) Thus, by selecting the priority routing method, a transaction acquirer grants card issuers control of where a transaction is routed to for authorization.

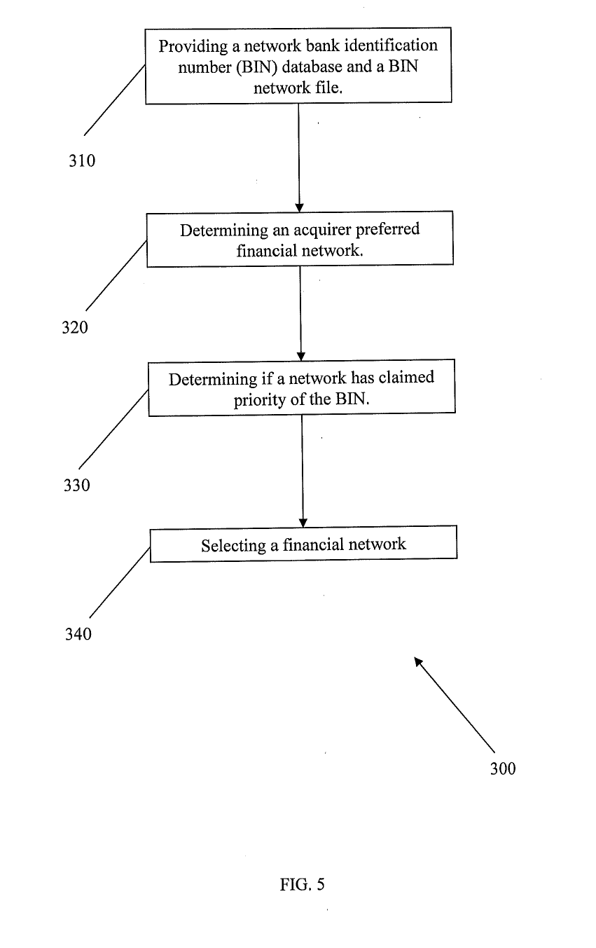

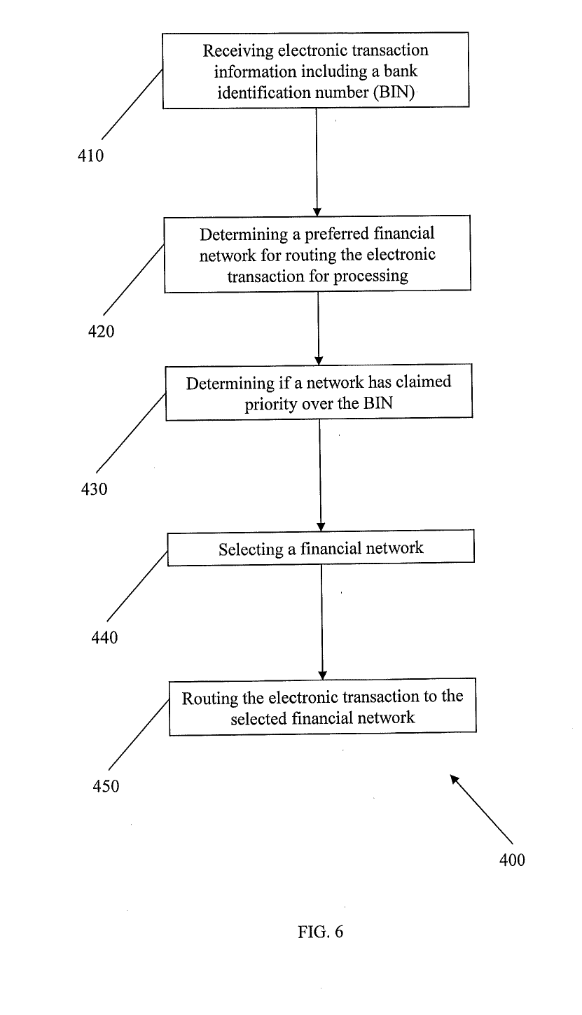

FIG. 5 illustrates a flow chart 300 demonstrating a method of selecting a financial network via the financial routing system of FIG. 1. FIG. 6 illustrates a flow chart demonstrating a method of selecting a financial network and routing an electronic transaction via the financial routing system of FIG. 1.

At step 310 of FIG. 5, the BIN database 106 and the BIN file 108 (as illustrated in FIGS. 1 and 3) are provided by the financial routing system 100 such that information provided by a transaction acquirer (routing profile stored in the BIN database 106) and information provided by a card issuer (stored in the BIN file 108) can be referred to when the system 100 is determining/selecting a financial network for routing a transaction. At step 320, the computer processing device 102 determines a preferred financial network of a transaction acquirer by searching the database 106 and referring to the acquirer's routing profile. The system 100 then searches the BIN file 108 for the BIN record corresponding to the card issuer associated with the transaction. By searching the BIN file, the computer processing device 102 can review the preferences set by the card issuer associated with a BIN record so that the computer processing device 102 can determine if a network and/or networks are claiming priority over the BIN. Based on the preferred routing method (i.e., acquirer routing method or priority routing method, discussed in detail above), the information provided in the transaction acquirer's routing profile, and the information in the BIN file, the computer processing device can select an appropriate financial network to which the transaction can be routed.

Similarly, as illustrated in FIG. 6, at step 410 the financial routing system 100 (as illustrated in FIGS. 2 and 3) receives, via communications network 120, an electronic financial transaction including any applicable indicators from a transaction acquirer 110 (110a or 110b). The system 100 searching the database 106 for the routing profile (including BIN) associated with the transaction acquirer and searches the BIN file 108 for a corresponding BIN record. Based on the information provided in the routing profile (e.g., preferred routing method, prioritized list of preferred networks), the card number, the transaction type selected, the BIN record values, etc., the system 100, at step 420, determines financial networks preferred by the transaction acquirer for routing the electronic transaction and, at step 430, determines if any networks claim priority over the BIN. At step 440, the system 100, based on the information provided in the routing profile retrieved from the database 106 and the BIN record retrieved from the BIN file 108, selects a financial network for routing the transaction.

For example, if the routing profile indicates that the preferred routing method is the acquirer routing method, the computer processing device would ignore any network's claim of priority (indicated in the BIN file 108) and, at step 430, would determine, based on the prioritized list of networks provided in the routing profile and based on a comparison between indicators provided in the financial transaction request with the flags in the BIN file, the preferred network for routing the financial transaction for authorization.

In another example, if the routing profile indicates that the preferred routing method is the priority routing method, the BIN file 108 (not illustrated in FIG. 4B) is referred to as well as the information provided in the routing profile. Specifically, the BIN file 108 is scanned to determine if a BIN match in the data records exists. If a BIN match does exist, the BIN file 108 is further referred for determining other matches and if the network is an ATM or POS priority routing network for the particular BIN. At step 430, the system then determines if any networks claim priority over the BIN (as discussed in detail above).

Thus, based on both the routing profile and the BIN record stored in the memory device 104 (e.g., acquirer routing method, priority routing method, flags in the BIN record, etc.), the computer processing device 102 can, at step 440, select an appropriate and preferred financial network and, at step 450, route the electronic financial transaction to the selected financial network.

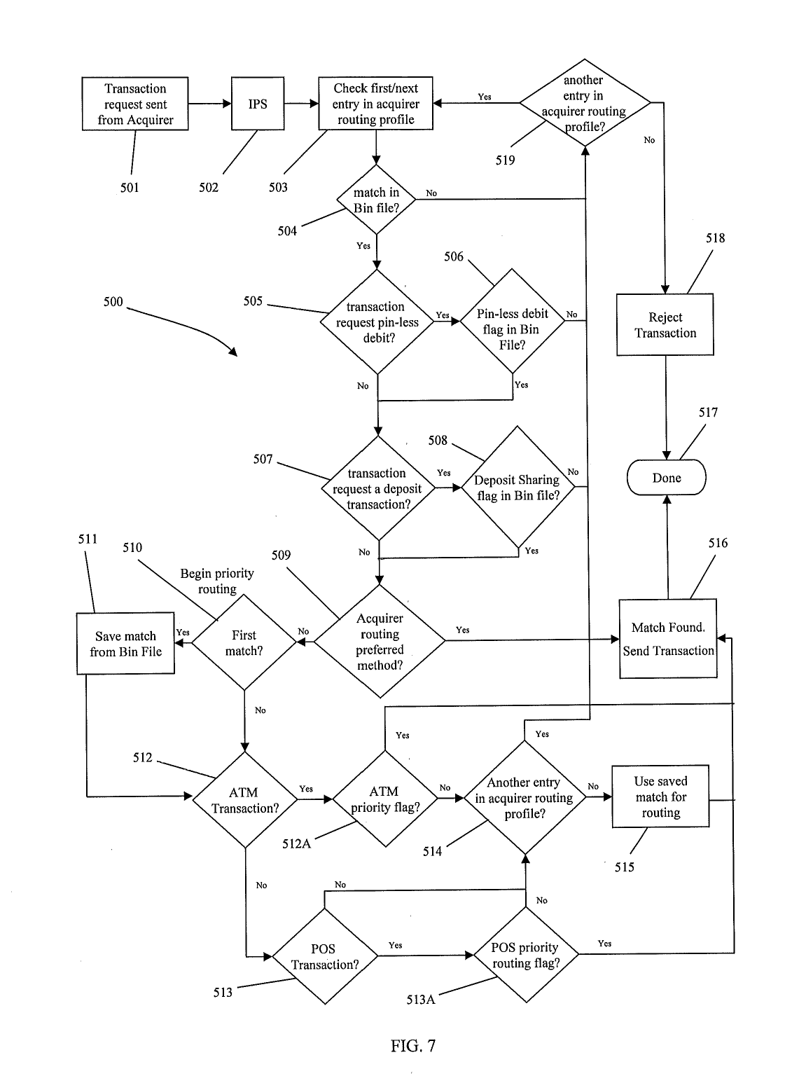

FIG. 7 illustrates a workflow diagram 500 depicting communication between individual parties of the financial system of FIGS. 2 and 3 in which the financial routing system 100 is implemented. Specifically, FIG. 7 illustrates a workflow diagram for determining a network to send/route a financial transaction (debit, credit, ATM, etc.) according to an embodiment and implementing either the acquirer routing method or the priority routing method as indicated in the transaction acquirer's routing profile.

At blocks 501 and 502, a transaction request, including an associated BIN and any applicable indicators (e.g., ATM indicator, POS indicator, etc.), is transmitted from a transaction acquirer (e.g., merchant terminal, ATM, etc.) and received at the financial routing system, respectively. The financial routing system searches the database for the routing profile corresponding to the acquirer of the transaction and proceeds to review the prioritized list of preferred networks in the routing profile, and at block 503, checks the first/next entry in the prioritized list. At block 504, the system determines if the entry in the prioritized list matches a network provided in a corresponding BIN record in the BIN file. If a match does not exist in the BIN file, the system proceeds by reviewing, once again, the prioritized list of preferred networks provided in the routing profile. If, at block 519, the system determines that no other preferred network is listed in the routing profile, the transaction is rejected at block 518, and the process completes at block 517. If, however, at block 519, the system determines that another preferred network is listed in the routing profile, the system checks the next preferred network at block 503 and, once again, determines if a match is found in the BIN record. This process continues until no other entries are found or until a match is found in the BIN record.

If, at block 504, the system determines that a match is found in the BIN record, the system proceeds by determining, at block 505, if the requested transaction is a PINIess debit transaction. If the requested transaction is a PINIess debit transaction (“yes”), the system looks to the BIN record to determine if it includes a PINIess debit flag. If no flag exists (“no”), the system proceeds by determining, at block 519, if another preferred network is listed in the routing profile (as discussed above). If a debit flag exists (“yes”), or if, at block 505 the system determines that the transaction request is not a PINIess debit (“no”), the system proceeds by determining if the transaction request is a deposit transaction.

If, at block 507, the system determines that the transaction is a deposit transaction (“yes”), the system looks to the BIN record to determine if it includes a deposit sharing flag. If no flag exists (“no”), the system proceeds by determining, at block 519, if another preferred network is listed in the routing profile (as discussed above). If a deposit sharing flag exists (“yes”), or, if at block 507, the system determines that the transaction is not a deposit transaction (“no”), the system proceeds by determining the acquirer's preferred routing method.

At block 509, the system determines if the preferred routing method is the acquirer routing method. If “yes”, the system proceeds, at block 516, by selecting a preferred network indicated by the transaction acquirer and sending/routing the transaction to the preferred network. The process then ends at block 517. If the system determines, at block 509, that the preferred routing method is not the acquirer routing method (“no”) (i.e., priority routing begins), the system proceeds, at block 510, by determining if a preferred network listed in the routing profile matches a network in the BIN record. If a match is found (“yes”), the match from the BIN record is saved at block 511, and the system proceeds by determining if the transaction is an ATM transaction, at block 512. Similarly, the system proceeds to block 512 if a match is not found in the BIN record at block 510.

If, at block 512, the system determines that the transaction is an ATM transaction (“yes”), the system looks to the BIN record to determine if it includes an ATM priority flag. If, at block 512A, no flag exists (“no”), the system proceeds by determining, at block 514 if the routing profile includes another entry in prioritized list of preferred networks. If another entry is found (“yes”), the system proceeds, at block 519 (as discussed above). If another entry is not found (“no”) then the system proceeds by using the saved match (from block 511) for routing the transaction. If, instead, at block 512, the system determines that the transaction is not an ATM transaction (“no”), the system proceeds by determining, at block 513, if the transaction is a POS transaction.

If the transaction, at block 513, is determined to not be a POS transaction (“no”), then the system proceeds by determining, at block 514 if the routing profile includes another entry in prioritized list of preferred networks. If another entry is found (“yes”), the system proceeds, at block 519 (as discussed above). If another entry is not found (“no”), then the system proceeds by using the saved match (from block 511) for routing the transaction. If system determines, at block 514, that the transaction is a POS transaction (“yes”), the system looks to the BIN record to determine if it includes a POS priority flag. If, at block 513A, the system determines that the BIN includes a priority flag (“yes”), then a match for a financial network is found, and the transaction is sent. If, however, at block 513A, the system determines that the BIN record does not include a priority flag (“no”), the system proceeds by determining, at block 519, if another preferred network is listed in the routing profile (as discussed above).

Regardless of the routing priority flag, if none of the networks in the routing profile have a match in the BIN record, the system, at block 518, rejects the transaction and ends the process.

The previous description of the various embodiments is provided to enable any person skilled in the art to make or use the invention recited in the accompanying claims of the disclosed system. While various exemplary embodiments of the disclosed system have been described above, it should be understood that they have been presented by way of example only, and not limitation. And, while exemplary embodiments of the disclosed system have been particularly shown and described with reference to embodiments thereof, it will be understood by those skilled in the art that many variations, modifications and alternative configurations may be made to the invention without departing from the spirit and scope of exemplary embodiments of the disclosed system.

Where methods described above indicate certain events occurring in certain order, the ordering of certain events may be modified. Moreover, while a process depicted as a flowchart, block diagram, etc., may describe the operations of the system in a sequential manner, it should be understood that many of the system's operations can occur concurrently. For example, although the financial routing system 100 is disclosed and illustrated (via FIGS. 5 and 6) as being configured to determine a preferred financial network of a transaction acquirer (by retrieving the routing profile in database 106) prior to determining if a network has claimed priority over a BIN (by retrieving the BIN record), in some embodiments, the system 100 can first retrieve the BIN record prior to retrieving the routing profile. In other embodiments, the system can concurrently determine a preferred financial network of a transaction acquirer and determine if a network has claimed priority over a BIN.

Thus, the breadth and scope of exemplary embodiments of the disclosed system should not be limited by any of the above-described embodiments but should be defined only in accordance with the following claims and their equivalents.

What is claimed is:

1. A method for determining a financial network, in a financial processing system, for routing an electronic transaction, the method comprising:
providing a network BIN database including a plurality of routing profiles, wherein each routing profile includes at least a corresponding bank identification number (BIN) and a prioritized list of preferred financial networks created by an entity acquiring a transaction;
providing a BIN file including a plurality of BINs and including information that indicates financial networks claims of priority over any of said BINs from the plurality of BINs;
determining, from a particular routing profile in said BIN database, a financial network from the prioritized list of preferred financial networks for routing said electronic transaction;
determining, from a particular BIN file, if at least one network claims priority over said BIN identified in said routing profile; and
selecting a financial network based on at least one of said BIN file information and said routing profile.

2. The method according to claim 1, wherein said entity acquiring said transaction is one of an automated teller machine (ATM) and a point of sale terminal (POS).

3. The method according to claim 1, wherein if the BIN file indicates that only one financial network claims priority over the BIN, the electronic transaction is routed to said one financial network.

4. The method according to claim 1, wherein if the BIN file indicates that at least one financial network does not claim priority over the BIN, the electronic transaction is routed to one of said preferred financial networks provided by the entity acquiring said transaction.

5. The method according to claim 1, wherein if the BIN file indicates that a plurality of financial networks claim priority over said BIN, the routing profile of said entity acquiring said transaction is used in conjunction with information in the BIN file for selecting a financial network that corresponds to a preferred network indicated in said routing profile and to a network indicated in said BIN file.

6. The method according to claim 1, wherein said entity acquiring said transaction includes one of financial institutions, intermediate financial networks, payment processing associations, and third-party processors.

7. The method according to claim 1, further comprising:
determining if said routing profile indicates a preference for routing said electronic transaction according to either (1) said routing profile alone or (2) both said routing profile and said BIN file.

8. The method according to claim 1, further comprising:
determining if said routing profile includes transaction types to be included or excluded from any of said preferred networks.

9. The method according to claim 1, wherein the list of preferred financial networks in said routing profile is prioritized by said entity.

10. The method according to claim 1, wherein the list of preferred financial networks provided in said routing profile is prioritized by said entity in an order of decreasing network interchange fees.

11. The method according to claim 1, wherein the list of preferred financial networks provided in said routing profile is prioritized by said entity in an order of increasing network interchange fees.

12. A method for routing an electronic transaction, in a financial processing system, to a financial network, the method comprising:
receiving, in a processor of the system, transaction information from an entity acquiring a transaction including a bank identification number (BIN);
determining, from a routing profile of the transaction acquirer, a preferred financial network for routing said electronic transaction, wherein said routing profile includes at least the BIN and a prioritized list of financial networks created by said transaction acquirer;
determining, from a BIN file, if at least one network is indicated as having a claim of priority over the BIN;
selecting a financial network based on at least one of the BIN file information and the routing profile of the transaction acquirer; and
routing said electronic transaction to said selected financial network for authorization.

13. The method according to claim 12, wherein said routing profile includes a preferred routing method selected by said transaction acquirer.

14. The method according to claim 12, wherein said routing profile indicates whether said transaction is to be routed only to one of the networks only listed in said prioritized list of preferred networks.

15. The method according to claim 12, wherein said routing profile indicates whether said transaction is to be routed according to both said routing profile of said transaction acquirer and to said information in said BIN file.

16. The method according to claim 12, further comprising:
determining if said routing profile of said transaction acquirer indicates transaction types to be included or excluded from any of said preferred networks.

17. The method according to claim 12, wherein said transaction acquirer is one of an automated teller machine (ATM) and a point of sale terminal (POS).

18. The method according to claim 12, wherein if said routing profile of said transaction acquirer does not indicate that said financial transaction is to be routed to a preferred financial network, and if the BIN file indicates that only one financial network claims priority over the BIN, the electronic transaction is routed to said one financial network.

19. The method according to claim 12, wherein if the BIN file indicates that at least one financial network does not claim priority over the BIN, the electronic transaction is routed to one of said preferred financial networks provided by the entity acquiring said transaction.

20. A financial processing system for determining a financial network for routing an electronic transaction, the system comprising:
a communication interface device configured to communicate with a communications network;
a memory device comprising:
a network BIN database including a plurality of routing profiles of transaction acquirers, wherein each routing profile includes at least a corresponding bank identification number (BIN) and a prioritized list of preferred financial networks of transaction acquirer, and
a BIN file including a plurality of BINs and indicating if any networks have claimed priority over any of said BINs from the plurality of BINs in said BIN file; and
a computer processing device configured to receive transaction information including a BIN from a transaction acquirer, to search said network BIN database for said routing profile of said transaction acquirer, to search said BIN file for network claims of priority, and to determine a financial network for routing said electronic transaction based on at least one of said routing profile and said network priority claims in said BIN file.
